(19) United States
(12) Patent Application Publication
(10) Pub. No.: US 2002/0062982 A1
(43) Pub. Date: May 30, 2002

(54) Microstrip line for microwave applications

(76) Inventors: Michael Nagel, Viersen (DE); Thomas Dekorsy, Aachen (DE); Heinrich Kurz, Aachen (DE)

Correspondence Address: J. Rodman Steele, Jr., Akerman, Senterfitt & Eidson, P.A., 222 Lakeview Avenue, 4th Floor, P.O. Box 3188, West Palm Beach, FL, 33402-3188, US

(21) Appl. No.: 10/053,428

(22) Filed: Jan. 17, 2002

Related U.S. Application Data
(63) Continuation of application No. PCT/DE00/02283, filed on Jul. 13, 2000.

(30) Foreign Application Priority Data
Jul. 23, 1999 (DE) 199 34 657.7
Aug. 25, 1999 (DE) 199 40 163.2

(51) Int. Cl. H01B 7/08

(52) U.S. Cl. 174/117 F

(57) ABSTRACT

The microstrip line for high frequency applications has a metallic ground electrode, a metallic signal conductor and a dielectric arranged between ground electrode and signal conductor. The dielectric consists of a relaxed, more specifically pre-stretched, polymer film that is coated on one side with a self-adhesive layer.

### CROSS REFERENCE TO RELATED APPLICATIONS

This application is a continuation of PCT/DE00/02283 filed Jul. 13, 2000, and claims the priority of DE 199 34 657.7 filed Jul. 23, 1999 and DE 199 40 163.2 filed Aug. 25, 1999.

### BACKGROUND OF THE INVENTION

The present invention is directed to a microstrip line for high frequency applications according to the preamble of the main claim.

Microstrip lines for high frequency applications in the microwave range have a characteristic structure. They consist of a generally flat ground electrode and of a generally striped signal conductor between the two of which there is arranged a dielectric which is either flat or striped. The ground electrode and the signal conductor have the features of high electric conductivity that may for example be realized by using metallic conductors. Typically, the ground electrode is located on the underside of a self-supporting dielectric. With thin dielectrics, the ground electrode can be applied to a substrate such as a printed circuit board made from epoxy resin. In order to achieve the smallest possible attenuation of this type of microstrip, it is among others necessary that the distance between ground electrode and signal conductor remains constant. In the construction mentioned, this distance is determined by the dielectric that serves as a spacer. The dielectric properties of the dielectric are also crucial to the conductive properties of a such type microstrip line.

U.S. Pat. No. 5,745,984 discloses a microstrip line for microwave applications that uses as a dielectric a thin base layer of benzocyclobutene (BCB) that is spin-coated onto a substrate and covered by a Kapton polyimide film. This stacked system is cured under pressure at temperatures of about 200° C. In this way it is possible to deposit onto a substrate a dielectric with a uniform thickness ranging from 35 to 65 μm. However, after curing, material stresses occur in the stacked dielectric system which degrade the bonding performance. Moreover, the layer of BCB takes more than one hour to cure.

Furthermore, U.S. Pat. No. 5,155,493 discloses a microstrip line for microwave applications that consists of a metallic ground electrode in the form of a metal foil coated on one side with a self-adhesive layer, of a dielectric formed from a dielectric foil that also has a self-adhesive layer on one side as well as of a metallic signal conductor again in the form of a metal foil that is coated on one side with a self-adhesive layer. PTFE (Teflon) is suggested as a dielectric. There are no precise indications as to the thickness of the layers. The use of Teflon as a dielectric is disadvantageous on one side with regard to cost since it is relatively expensive, on the other side it also presents technical disadvantages since it has a less favorable relative permittivity. Furthermore, the bonding of the microstrip line causes problems because the bonding effect on Teflon is poor.

Therefore, it is the object of the present invention to indicate a microstrip line for high frequency applications, more specifically in the millimeter-wave range, that is provided with a particularly simple structure, can be manufactured at low cost and is advantageous both with regard to durability and to transmission properties.

### SUMMARY OF THE INVENTION

The solution to this object is achieved by a microstrip line for high frequency applications that has the features recited in the main claim. A such type microstrip line uses a relaxed polymer film as a dielectric. “Relaxed” means in this connection that internal stresses which occur while manufacturing the polymer film are already eliminated while producing the polymer film i.e., that the polymer film is already largely relaxed in its thermodynamic final state. Such a relaxed condition may be achieved by thermal treatment for example, or by way of a controlled stretch forming process. A polymer film resulting from such a stretch forming process is called pre-stretched.

A microstrip line for high frequency applications in accordance with the invention is particularly easy to produce. The dielectric, which is coated on one side with a self-adhesive layer, is bonded to a metal-coated substrate, for example a printed circuit board made from epoxy resin that has been electrolytically metal-plated. Advantageously, the dielectric may be prefabricated so as to be ready for use and may more specifically be wound on a reel. It preferably has the shape of a tape. The width of the tape is selected to be adapted to the intended microwave application. The thickness of the tape is selected to be adapted to the microwave frequency. After the tape is applied, it may be cut off at the edge of the substrate by means of a hot blade for example. It is also possible to prefabricate the dielectric in such a manner that it is adapted to the shape of the substrate, thus permitting more accurate edge bonding. Then, the metallic signal electrode is applied to the upper side of the dielectric by means of a suited method, such as thermal vaporization for example.

The microstrip line for high frequency applications in accordance with the invention has particularly favorable transmission properties in the millimeter-wave range when the stacked dielectric system, which consists of the dielectric and of the self-adhesive layer applied thereon, has a relative permittivity εᵣ of less than 2.5 in the frequency range between 500 MHz and 1 THz, more specifically in the frequency range between 1 GHz and 500 GHz. The stacked dielectric system preferably has a relative permittivity of less than 2.4.

For applications in the millimeter-wave range, it proved particularly advantageous to provide the dielectric used for the microstrip line according to the invention, more specifically the stacked dielectric system consisting of the dielectric and of the self-adhesive layer, with a mean thickness ranging between 25 μm and 75 μm. Its thickness of preference is 50 μm. A particularly small attenuation is obtained when the variations in thickness δd of the dielectric, but more specifically of the stacked dielectric system consisting of the dielectric and of the self-adhesive layer provided in portions of the microstrip line that are characterized by a constant mean thickness d, are less than 5%, preferably less than 2% and more specifically less than 1% of the mean thickness d.

Particular advantages derive from the use of polypropylene as a dielectric for the microstrip line according to the invention. On one side, polypropylene displays the required dielectric properties, on the other, it may be submitted without any problem to such a treatment during the manufacturing process that the required properties regarding the accuracy of its thickness and above all its freedom from stress can be met. More specifically, polypropylene can be brought into the required relaxed condition by means of a stretch forming process. Furthermore, polypropylene can be fabricated at particularly low cost.

A coating with acrylate co-polymer proved particularly suited for the inventive self-adhesive layer adapted to be applied onto the dielectric.

Advantageously, the combination consisting of a polypropylene film which is coated on one side with a self-adhesive layer of acrylate co-polymer is already commercially available in the form of the Tesa tape marketed by the firm of Beiersdorf.

Both the metallic ground electrode and the metallic signal conductor can be deposited either by means of thermal vaporization or by means of electronbeam evaporation, by electrolytic deposition or by sputtering. Furthermore, both the metallic ground electrode and the metallic signal conductor can be manufactured from a metal film coated with a self-adhesive layer. Both the metallic signal conductor and the metallic ground electrode of the microstrip line according to the invention may be structured by means of current lithographic techniques. As a result thereof, it is possible to form passive microwave component parts such as for example a kink in a line, a width graduation in a line, a device to open circuit a line, a device to short circuit a line, a filter or an antenna.

Further characteristics and advantages of the microstrip line according to the invention will become apparent in the subordinate claims and in the following exemplary embodiments that will be discussed with reference to the drawing.

### BRIEF DESCRIPTION OF THE DRAWINGS

FIG. 1 is a cross section through a microstrip line according to the invention that is applied to an epoxy printed circuit board,

FIG. 2 is a perspective view of the same microstrip line,

FIG. 3 is a graphic representation of comparative measurements made on a microstrip with a dielectric made from BCB and on a microstrip with a dielectric made from a polypropylene film, and

FIG. 4 is a schematic representation of a device for unreeling and laminating the dielectric formed into a tape.

### DETAILED DESCRIPTION OF A PREFERRED EMBODIMENT

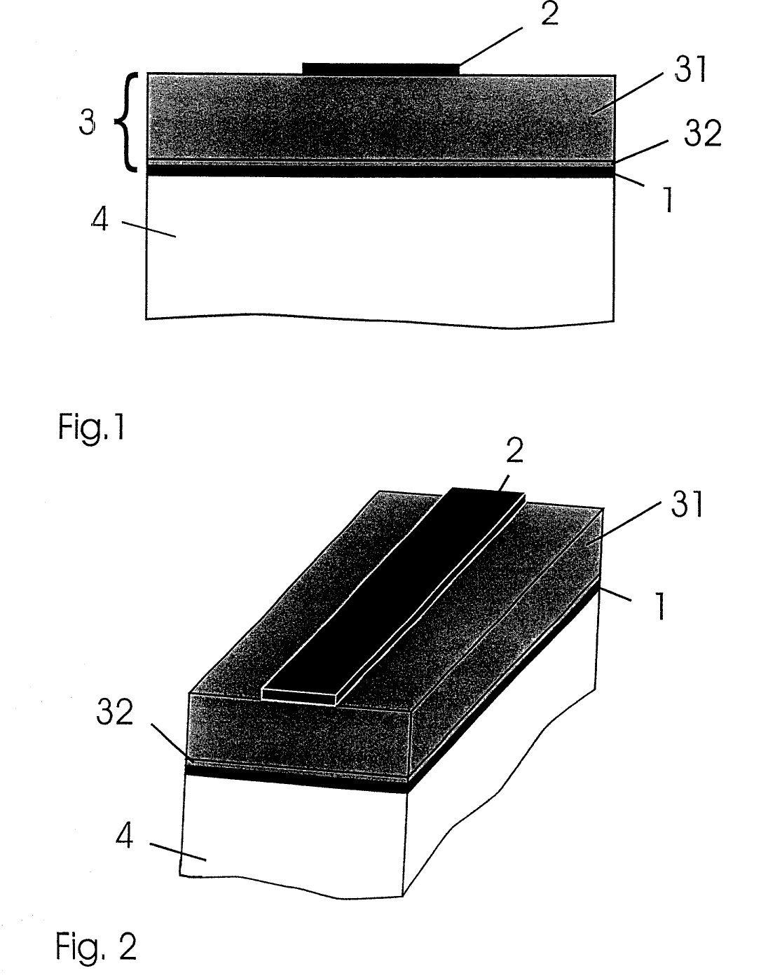

FIG. 1 illustrates the basic structure of a microstrip line according to the invention. A layer of metal is electroplated onto an epoxy printed circuit board 4, said layer of metal constituting the metallic ground electrode 1. Its thickness typically amounts to from some nanometers to several um. The dielectric 3, which is formed by the stacked dielectric system consisting of a relaxed polymer film 31 that is provided on one side with a self-adhesive layer 32 is applied to this metallic ground electrode 1. The relaxed polymer film is thereby made from polypropylene and has a thickness of 52 μm. The self-adhesive layer 32 is made from acrylate co-polymer and has a thickness of approximately 5 μm.

A metallic signal conductor 2 is vaporized onto the upper side of the relaxed polymer film 31. The thickness of the signal conductor 2 is selected for allowing metallic conductive properties to develop in the metallic signal conductor. The thickness of the metallic signal conductor 2 deposited again amounts to at least some nm up to some μm. All the metals that have good electric conductive properties in the frequency range in question are hereby suited. However, other materials may be used for constructing the metallic signal conductor 2 inasmuch as their electrically conductive properties are sufficient. Electrically conductive polymers are cited here as an example thereof. The same applies to the metallic ground electrode 1. To deposit the metallic ground electrode 1 and the metallic signal conductor 2, all kinds of methods of vaporization are suited, for example thermal vaporization or electron-beam evaporation, sputtering processes or electrolytic deposition. The thus deposited metal electrodes can be structured by means of current lithographic methods. Photolithographic methods and electron-beam lithography, respectively followed by appropriate etching methods, are to be mentioned here by way of example.

The perspective view in FIG. 2 illustrates once more the geometric situation of a microstrip line in accordance with the invention. It particularly shows the geometry of a signal strip conductor 2.

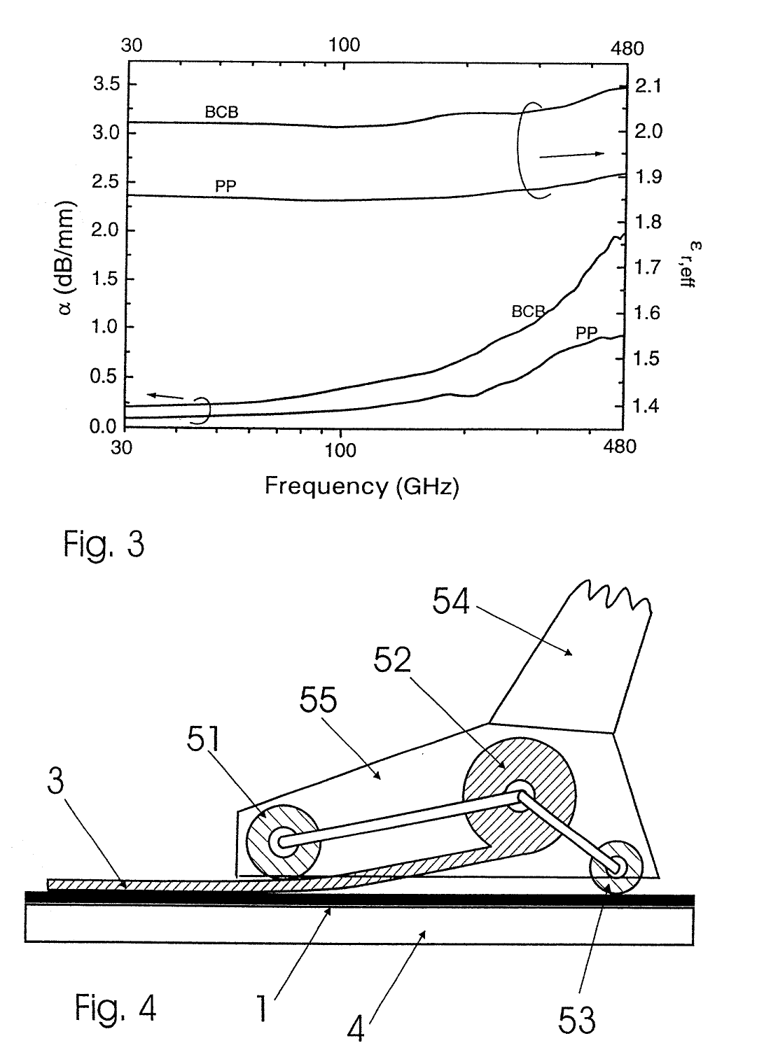

FIG. 3 shows the results of a comparative measurement made on two microstrip lines in the millimeter-wave range. The curves that are marked with “BCB” refer to a microstrip line whose dielectric 3 consisted of a layer of BCB. The curves marked with “PP” refer to a microstrip line in accordance with the invention whose dielectric 3 consisted of a polypropylene film. The coating thicknesses d of the two dielectrics 3 (or of the stacked dielectric systems) and the width of the signal conductor w and the thickness of the metal coating t were comparable. In detail, d(PP)=57 μm, d(BCB)=54 μm, w=31 μm and t=0.5μ. The two upper curves, which are referred to the right abscissa, illustrate the gradient of the effective relative permittivity εᵣ, eff over a frequency range from 30 through 480 GHz. It very well illustrates that, over the entire frequency range, the effective permittivity of the BCB line is markedly higher than the effective permittivity of the waveguide made from polypropylene. In the first case, the effective permittivity ranges from 2.05 through approximately 2.1 over the entire frequency range, in the last-mentioned case, the effective permittivity ranges from 1.85 through 1.91 over the entire frequency range.

The lower group of curves shows the gradient of the attenuation a of the two microstrip lines, the same system of notation having been used as before. In the case of the microstrip line that is based on a layer of BCB the attenuation measured amounts to a minimum of 0.2 dB/mm and increases to up to 2 dB/mm for high frequencies. By contrast, the attenuation of the microstrip line according to the invention, which is based on a polypropylene film, amounts to a minimum of approximately 0.09 dB/mm and increases at the upper end of the frequency range to a maximum of 0.8 dB/mm. This advantageous result of the microstrip line in accordance with the invention is on one side the result of the advantageous dielectric properties of polypropylene, on the other side it expresses the fact that the microstrip line according to the invention may be produced with excellent accuracy with regard to the distance between the metallic ground electrode 1 and the metallic signal conductor 2.

For bonding the dielectric 3 that is coated on one side with a self-adhesive layer, the following method proved to be particularly suited. By means of the self-adhesive layer 32, the dielectric tape 3 is bonded to the metallic ground electrode 1 on a small contact area. Starting from said ground electrode, the dielectric 3 is laminated onto the metallic ground electrode 1 without any inclusion of air bubbles or dust by means of a roll 51. This is advantageously achieved by means of a device that includes on one side an uncoiler 52 for the dielectric formed into a tape and, on the other side a roll 51, preferably a rubber roll that may more particularly be moistened and serves to laminate the dielectric onto the ground electrode 1. There may more particularly be provided to adjust an angle defined between the dielectric tape 3 and the metallic ground electrode 1 by means of suited auxiliary reels 53 and of a suited arrangement of uncoiler 52 and roll 51 relative to each other during the process of unrolling. A grip 54 provides ease of handling. A cover 55 serving to protect from dust is furthermore provided. A such type device is shown in FIG. 4. Operating errors in bonding the dielectric may thus largely be excluded.

1. A microstrip line for high frequency applications consisting of a metallic ground electrode, a metallic signal conductor and a dielectric means arranged between the ground electrode and the signal conductor, wherein the dielectric means consists of a relaxed polymer film that is coated on one side with a self-adhesive layer.

2. The microstrip line according to claim 1, wherein the dielectric means has a relative permittivity εᵣ of less than 2.5 in the frequency range between 500 MHz and 1 THz.

3. The microstrip line according to claim 1, wherein the mean thickness d of the dielectric means lies between 5 μm and 100 μm.

4. The microstrip line according to claim 1, wherein the dielectric means shows variations in thickness δd of its mean thickness d, the variations in thickness δd being less than 5% of the mean thickness d.

5. The microstrip line according to claim 1, wherein the dielectric means is made from polypropylene.

6. The microstrip line according to claim 1, wherein the self-adhesive layer is made from an acrylate copolymer.

7. The microstrip line according to claim 1, wherein at least one of the metallic ground electrode and the metallic signal conductor are deposited by one of the following deposition procedures: thermal vaporization, electron-beam evaporation, electrolytic deposition and sputtering.

8. The microstrip line according to claim 1, wherein at least one of the metallic ground electrode and the metallic signal conductor consists of a metal film coated with a self-adhesive layer.

9. The microstrip line according to claim 1, wherein at least one of the metallic signal conductor and the ground electrode are structured by means of a lithographic technique.

10. The microstrip line according to claim 1, wherein the dielectric means has a shape, the shape of the dielectric means being prefabricated according to the shape of the substrate.

11. The microstrip line according to claim 1, wherein the microstrip line forms a passive high-frequency component part such as for example a kink in a line, a width graduation in a line, a device to open circuit a line, a device to short circuit a line, a filter or an antenna.

12. The microstrip line according to claim 1, wherein the relaxed polymer film is a pre-stretched film.

13. The microstrip line according to claim 1, wherein the dielectric means and the self-adhesive layer form a stacked dielectric system having a relative permittivity εᵣ of less than 2.5 in the frequency range between 500 MHz and 1 THz.

14. The microstrip line according to claim 1, wherein the dielectric means has a relative permittivity εᵣ of less than 2.5 in the frequency range between 1 GHz and 500 GHz.

15. The microstrip line according to claim 1, wherein the dielectric means and the self-adhesive layer form a stacked dielectric system having a relative permittivity εᵣ of less than 2.5 in the frequency range between 1 GHz and 500 GHz.

16. The microstrip line according to claim 1, wherein the dielectric means and the self-adhesive layer form a stacked dielectric system having a mean thickness d between 5 μm and 100 μm.

17. The microstrip line according to claim 1, wherein the dielectric means and the self-adhesive layer form a stacked dielectric system having a mean thickness d amounting to 50 μm.

18. The microstrip line according to claim 1, wherein the dielectric means shows variations in thickness δd of its mean thickness d, the variations in thickness δd being less than 2% of the mean thickness d.

19. The microstrip line according to claim 1, wherein the dielectric means shows variations in thickness δd of its mean thickness d, the variations in thickness δd being less than 1% of the mean thickness d.

20. The microstrip line according to claim 1, wherein the dielectric means and the self-adhesive layer form a stacked dielectric system, the stacked dielectric system having a mean thickness d and showing variations in thickness δd of its mean thickness d, the variations in thickness δd being less than 5% of the mean thickness.

21. The microstrip line according to claim 1, wherein the dielectric means and the self-adhesive layer form a stacked dielectric system, the stacked dielectric system having a mean thickness d and showing variations in thickness δd of its mean thickness d, the variations in thickness δd being less than 2% of the mean thickness.

22. The microstrip line according to claim 1, wherein the dielectric means and the self-adhesive layer form a stacked dielectric system, the stacked dielectric system having a mean thickness d and showing variations in thickness δd of its mean thickness d, the variations in thickness δd being less than 1% of the mean thickness.
